(19) United States
(12) Patent Application Publication
(10) Pub. No.: US 2007/0190476 A1
(43) Pub. Date: Aug. 16, 2007

(54) ORTHODONTIC TOOTH RETENTION SYSTEM

(76) Inventor: Eugene L. Dellinger, Fort Wayne, IN (US)

Correspondence Address: BAKER & DANIELS LLP;111 E. WAYNE STREET, SUITE 800, FORT WAYNE, IN, 46802, US

(21) Appl. No.: 11/689,674

(22) Filed: Mar. 22, 2007

Related U.S. Application Data
(63) Continuation-in-part of application No. 11/122,946, filed on May 5, 2005.

(51) Int. Cl. A61C 3/00

(52) U.S. Cl. 433/3

(57) ABSTRACT

A method and apparatus for delivering an orthodontic retainer system wherein pairs of magnets are applied to adjacent teeth in a patient's mouth. The retainer system may include a carrier portion having a recess which contains an adhesive material. The magnets may be embedded in the adhesive material. Once positioned on adjacent teeth, the adhesive material is cured and the carrier is removed to reveal an envelope or shaped profile of the adhesive material. The shaped profile of the adhesive material obviates the need to post-form adhesive material around the magnets after attaching the magnets to the adjacent teeth. Furthermore, the shaped profile may include a smooth surface. The adhesive material may also be aesthetically colored to match the coloring of the adjacent teeth. The carrier may be formed of a water soluble material or may be a flexible material.

### CROSS REFERENCE TO RELATED APPLICATIONS

This application is a continuation-in-part of co-pending U.S. patent application Ser. No. 11/122,946, filed May 5, 2005, entitled METHOD AND APPARATUS FOR POSITIONING AN ORTHODONTIC APPLIANCE, the disclosure of which is hereby expressly incorporated herein by reference.

### BACKGROUND

1. Field of the Disclosure

The present disclosure relates to orthodontics, and, more particularly, to an orthodontic tooth retention system for delivering pairs of magnets for application to adjacent teeth to retain the teeth in a desired position.

2. Description of the Prior Art

Many types of orthodontic appliances incorporating a variety of arrangements of mutually attracted elements, such as magnets, have been proposed. Some prior arrangements use magnets as a retaining device to retain teeth in a corrected position as a secondary function to primary tooth movement. Magnetic elements have also been used in combination with dentures for retaining the dentures in the mouth. When magnets are used as retaining devices, the magnets are placed onto teeth and the attractive force between the magnets provides a retaining force, thereby preventing the adjacent teeth from moving apart.

Other arrangements use magnets as corrective devices to move teeth into a corrected position. The conventional way for moving teeth in the mouth usually involves orthodontic appliances, such as braces and wires that exert a constant force on the tooth that needs to be moved. An elastic member creating the constant force must periodically be adjusted by a dentist or orthodontist. Many times dental appliances, including a retainer wire, are required across the front of the teeth to prevent excessive movement of the teeth.

### SUMMARY

The present disclosure provides a method and apparatus for delivering an orthodontic retainer system wherein pairs of magnets are applied to adjacent teeth in a patient's mouth. The retainer system may include a carrier portion having a recess which contains an adhesive material. The magnets may be embedded in the adhesive material. Once positioned on adjacent teeth, the adhesive material is cured and the carrier is removed to reveal an envelope or shaped profile of the adhesive material. The shaped profile of the adhesive material obviates the need to post-form adhesive material around the magnets after attaching the magnets to the adjacent teeth. Furthermore, the shaped profile may include a smooth surface. The adhesive material may also be aesthetically colored to match the coloring of the adjacent teeth. The carrier may be formed of a water soluble material or may be a flexible material.

In one embodiment, a method and apparatus for delivering an orthodontic appliance is provided wherein pairs of mutually attracted members, e.g., magnets, are applied to adjacent teeth, thereby retaining the teeth in a desired position, for example, after the teeth have been moved to new positions by conventional orthodontic techniques. The magnets may be very small magnets which may be gold plated. Generally, the magnets are biocompatible.

In an exemplary embodiment, the method of applying the magnets to the teeth includes placing two magnets on opposite sides of a thin, non-magnetic strip of material, such as Mylar® material, available from DuPont Teijin Films, of Hopewell, Va. Because the magnets are attracted to each other, they will stay in place on opposite sides of the strip. An adhesive is applied to each magnet, and/or to the teeth to which the magnets will be secured. In one exemplary embodiment, primer material is applied to the adjacent teeth in the locations where the magnets are to be placed and the adhesive is applied to the magnets. The strip is then placed in the space between two adjacent teeth. The thin, non-magnetic strip is then drawn forward between the adjacent teeth until the adhesive material on the magnets touches the primer material on the adjacent teeth. This allows ideal positioning of the magnets as determined by their individual magnetic fields. An ultraviolet or visible light source can be used to cure the adhesive, and retain each of the magnets in place on one of the two adjacent teeth. The strip is then removed by pulling it through the space between the adjacent teeth, thereby leaving behind the magnets secured to the adjacent teeth. The magnets will retain the adjacent teeth in their positions because of the magnetic attraction between the magnets.

In one form thereof, the present disclosure provides an orthodontic retainer system for use on teeth, including a delivery member; at least one carrier including a recess, the carrier coupled to the delivery member; an adhesive material contained within the recess; and at least one magnet disposed within the recess and at least partially surrounded by the adhesive.

In another form thereof, the present disclosure provides a method of applying a pair of magnets to a pair of adjacent teeth each having a lingual side, including the steps of: providing at least one carrier having a recess containing an adhesive material and a pair of magnets; abutting the adhesive material with the lingual side of each of the pair of adjacent teeth; curing the adhesive material; and removing the carrier from the adhesive material.

In yet another form thereof, the present disclosure provides a method of applying a pair of magnets to a pair of adjacent teeth each having a lingual side, including the steps of magnetically coupling the pair of magnets to one another on opposite sides of a delivery member with the delivery member captured therebetween; abutting the pair of magnets with the lingual side of each of the pair of adjacent teeth by sliding the delivery member between the pair of adjacent teeth; and securing the pair of magnets respectively to the pair of adjacent teeth such that the pair of magnets are maintained in non-contact relationship with each other.

### BRIEF DESCRIPTION OF THE DRAWINGS

The above mentioned and other features of this disclosure, and the manner of attaining them, will become more apparent and will be better understood by reference to the following description of embodiments of the disclosure taken in conjunction with the accompanying drawings, wherein:

FIG. 1 is a perspective view of a delivery member of the present disclosure, further illustrating a coupled pair of mutually attracted members;

FIG. 2 is an occlusal view of an individual's teeth, further illustrating the several steps of the method of the present disclosure;

FIG. 3 is an occlusal view of a portion of an individual's teeth, further illustrating an alternative embodiment orthodontic retainer system according to the present disclosure;

FIG. 4 is an occlusal view of a portion of an individual's teeth, further illustrating the orthodontic retainer system of FIG. 3;

FIG. 5 is a posterior view of the portion of an individual's teeth shown in FIG. 4;

FIG. 6 is a perspective view of a capsule of the present disclosure, further illustrating a mutually attracted dental module encapsulated therein;

FIG. 7A is a partial sectional occlusal view of an orthodontic retainer system according to another embodiment of the present disclosure;

FIG. 7B is a cross-sectional view of a portion of the system of FIG. 7A, taken along line 7B-7B of FIG. 7A;

FIGS. 8-19 are partial sectional occlusal views of exemplary steps in a method of attaching a pair of magnets to a pair of adjacent teeth, wherein:

FIG. 8 shows the pair of magnets spaced from the pair of adjacent teeth before attachment thereto;

FIG. 9 shows the pair of magnets temporarily attached to the pair of adjacent teeth prior to curing the adhesive material;

FIG. 10 shows a curing instrument for curing the adhesive material;

FIG. 11 shows an instrument for dispensing water onto the system;

FIG. 12 shows the carrier partially dissolved;

FIG. 13 shows the carrier completely dissolved to reveal the adhesive material profile; and

FIG. 14 shows the removal of an alternative carrier with a dental instrument.

Corresponding reference characters indicate corresponding parts throughout the several views. Although the exemplifications set out herein illustrate the disclosure, the embodiments disclosed below are not intended to be exhaustive or to be construed as limiting the scope of the invention to the precise forms disclosed.

### DETAILED DESCRIPTION

The present disclosure provides a method and apparatus for delivering an orthodontic retainer system wherein pairs of magnets are applied to adjacent teeth in a patient's mouth. The retainer system may include a carrier portion having a recess which contains an adhesive material. The magnets may be embedded in the adhesive material. Once positioned on adjacent teeth, the adhesive material is cured and the carrier is removed to reveal an envelope or shaped profile of the adhesive material. The shaped profile of the adhesive material obviates the need to post-form adhesive material around the magnets after attaching the magnets to the adjacent teeth. Furthermore, the shaped profile may include a smooth surface. The adhesive material may also be aesthetically colored to match the coloring of the adjacent teeth. The carrier may be formed of a water soluble material or may be a flexible material.

Referring now to FIG. 1, orthodontic retainer system 10 is shown, including strip or delivery member 12 and mutually attracted dental modules 14. Mutually attracted dental modules 14 are releasably coupled by attractive forces to opposite sides of delivery member 12. The phrase “mutually attracted dental modules,” for the purposes of this document, generally means two separate bodies which have a mutual attraction for each other and which are suitable for placement in the mouth for a period of time. For example, in one embodiment, each mutually attracted dental module 14 may comprise a magnet or any other suitable device capable of mutual attraction, i.e., electrostatic members. When mutually attracted dental modules 14 are magnets, they are coupled together on delivery member 12 via magnetic forces. Each mutually attracted dental module 14 has a dimension D (FIG. 1), such as a height or a diameter, in the range of 0.010 to 0.040 inches, preferably in the range of 0.038 to 0.039 inches. In one form thereof, mutually attracted dental module 14 is in the shape of a cylinder, as shown in FIG. 1. Mutually attracted dental module 14 may also take different forms, including those having cross-sectional shapes such as various polygonal shapes. Each mutually attracted dental module 14 is made of a biocompatible material to allow its implantation in the mouth for a period of time. For example, each mutually attracted dental module 14 may be gold-plated, or, alternatively, could be comprised entirely of gold. In another embodiment, each mutually attracted dental module 14 comprises neodymium iron. As shown in FIG. 1, a quantity of adhesive 16 can be applied to an anterior face of each mutually attracted dental module 14 to facilitate securement of the same to a tooth.

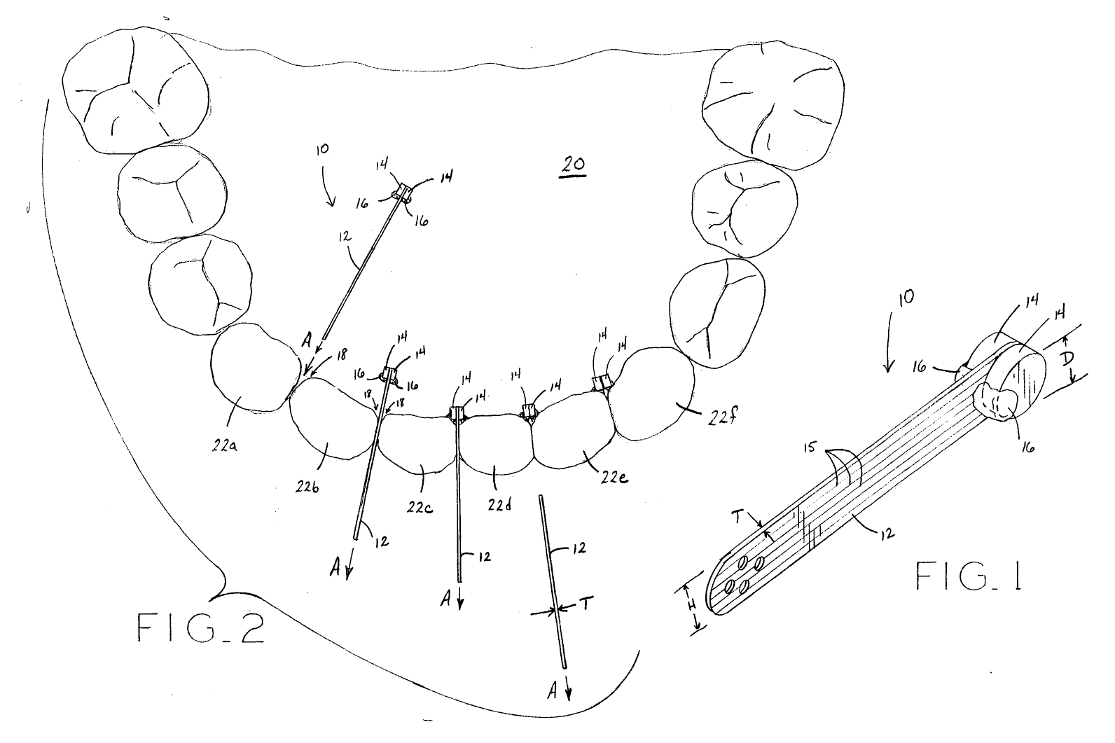

Referring to FIGS. 1 and 2, delivery member 12 is a thin, non-magnetic strip of material, such as Mylar™ material, having a thickness T which, in one embodiment, may be may be as small as 0.001, 0.002, 0.003, 0.004, or 0.005 inches or as large as approximately 0.012, 0.011, 0.010, 0.009, 0.008, 0.007, or 0.006 inches. Thickness T is such as to allow delivery member 12 to pass between a pair of adjacent teeth 22, for example, teeth 22a and 22b. The length of delivery member 12 can be any size to facilitate an easy access for an orthodontist for pulling delivery member 12 between a pair of adjacent teeth 22a and 22b, as will be described hereinbelow. Delivery member 12 may also include scribe marks 15 which may be lettered or numbered accordingly to provide a depth gauge, thereby providing the orthodontist with an indication of the depth of delivery member 12 with respect to adjacent teeth 22. In an alternative embodiment, delivery member 12 may be part of a continuous piece of material which has pairs of mutually attracted dental modules 14 carried thereon at various spaced distances. The orthodontist would then cut the continuous piece of material just beyond the location of mutually attracted dental modules 14 to obtain a single orthodontic retainer system 10. Height H of delivery member 12 may range from 0 to 10 millimeters, but height H may be increased depending on the desired application.

Referring now to FIG. 2, the method of applying magnetic orthodontic retainer system 10 will be described. Mouth 20 is shown including a plurality of teeth 22a-22f. In one embodiment, a pair of mutually attracted dental modules 14 are placed on opposite sides of delivery member 12, whereby the attractive coupling between mutually attracted dental modules 14 retains them in place on delivery member 12. Mutually attracted dental modules 14 are not bonded to delivery member 12, rather, delivery member 12 functions to carry mutually attracted dental modules 14 to their final destination on adjacent teeth. A quantity of adhesive 16 is then placed on mutually attracted dental modules 14, or, alternatively, adhesive 16 may be applied to mutually attracted dental modules 14 prior to placing modules 14 on opposite sides of delivery member 12. Furthermore, primer material 18 is applied to a posterior surface of adjacent teeth 22, i.e., teeth 22b and 22c, in a location where adhesive 16 applied to mutually attracted dental modules 14 will contact the surface of teeth 22b and 22c. Primer material 18 may comprise a material such as acid for etching a posterior surface of each tooth 22. Primer material 18 may also comprise chemical etching or any type of material to facilitate bonding with adhesive 16.

Referring still to FIG. 2, delivery member 12, with mutually attracted dental modules 14 carried thereon, is placed between a pair of adjacent teeth, for example, between teeth 22b and 22c. Delivery member 12 is then pulled in the general direction of Arrow A, as shown by delivery member 12 being pulled between teeth 22b and 22c. Arrow A generally indicates an anterior direction, i.e., towards the front of the mouth or from the lingual side of the teeth towards the facial side of the teeth. Delivery member 12 is pulled until the pair of mutually attracted dental modules 14 contacts the teeth, as shown, for example, by mutually attracted dental modules 14 contacting teeth 22c and 22d. At this point, adhesive 16 contacts primer material 18. Adhesive 16 is then cured to harden adhesive 16 and attach mutually attracted dental modules 14 to teeth 22c and 22d. In one embodiment, an ultraviolet or visible light source (not shown) may be used to cure adhesive 16.

To complete the operation, delivery member 12 is pulled further anteriorly to remove delivery member 12 from between any teeth, for example, as shown by delivery member 12 removed from between teeth 22d and 22e. Once delivery member 12 has been completely removed, mutually attracted dental modules 14 remain attached to teeth 22e and 22f, for example, to provide an orthodontic retainer system. Because mutually attracted dental modules 14 are not secured to delivery member 12 and are only carried thereon via the mutual attraction between mutually attracted dental modules 14, delivery member 12 simply slides between mutually attracted dental modules 14 and the adjacent teeth to which modules 14 are attached for removal of delivery member 12 from mouth 20. Movement of delivery member 12 after curing will not disturb dental modules 14 because the force coupling dental modules 14 to delivery member 12 is less than the force adhering dental modules 14 to the teeth. Once placed, mutually attracted dental modules 14 retain adjacent teeth without the need for other, more cumbersome orthodontic appliances.

Although the above-described embodiments describe mutually attracted dental modules 14, the present disclosure also contemplates a method and apparatus for positioning mutually repelled dental modules 14′ (not shown). In this embodiment, mutually repelled dental modules 14′ could be positioned on adjacent teeth such that modules 14′ repel one another to move the adjacent teeth to a corrected position. Modules 14′ could be detachably adhered to delivery member 12 with a force less than the force adhering dental modules 14′ to the teeth. In one embodiment, modules 14′ may be magnets. If modules 14′ comprise magnets, the magnets would be oriented in a repelling, non-attractive position, for example, with the north pole of one module 14′ lined up with the north pole of the other module 14′. In contrast and as described above, mutually attracted dental modules 14 would be positioned such that, if modules 14 were magnets, the south pole of one module 14 would line up with the north pole of another module 14, such as to provide an attractive force between the two modules 14. Mutually repelled dental modules 14′ could be delivered and positioned on adjacent teeth in the mouth in a substantially identical manner as described above for modules 14.

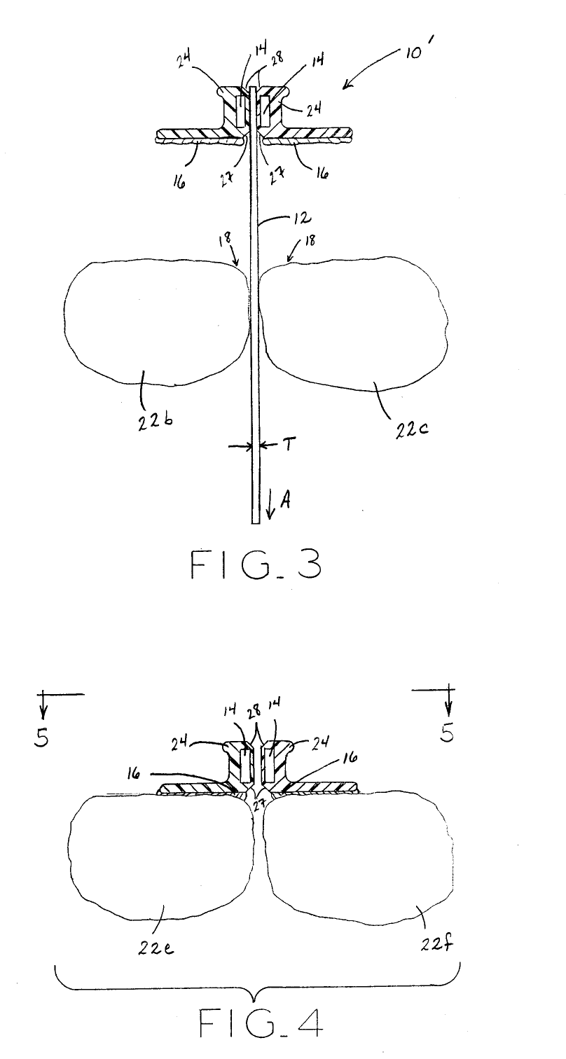

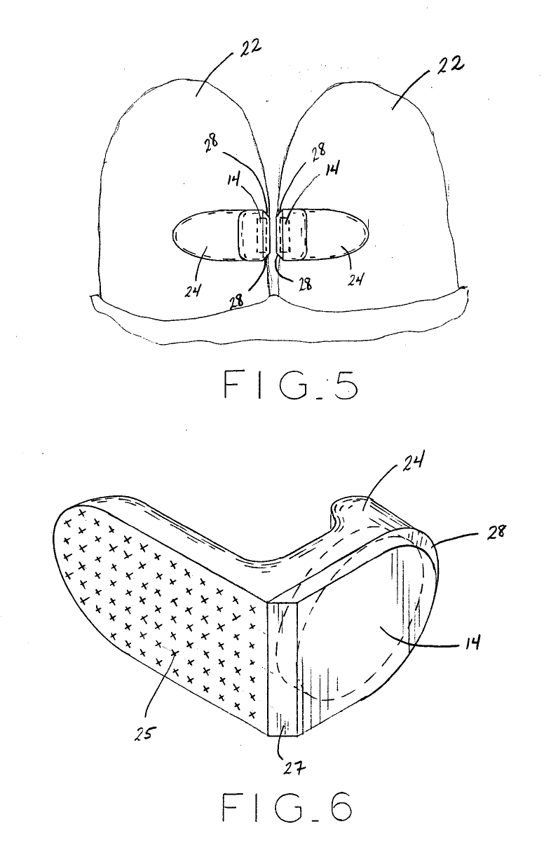

Referring now to FIG. 3, in an alternative embodiment, orthodontic retainer system 10′ is shown, including strip or delivery member 12 and mutually attracted dental modules 14 encapsulated within capsules 24. Capsules 24 may be formed of metal, ceramic, composite, or any other suitable biocompatible material. In an exemplary embodiment, capsule 24 should not include any sharp edges or irritating features such as features which possibly could cause harm to the tongue or other portions of the mouth. Referring now to FIG. 6, capsule 24 may include surface 25 which facilitates the application of adhesive 16 to capsule 24. Surface 25 may be a grid, mesh, or series of geometric undercuts in capsule 24 to provide an abrasive surface to which adhesive 16 is applied. Capsule 24 may include beveled edge 27 and beveled edge 28. Beveled edges 27 and 28 are provided to facilitate flossing of adjacent teeth 22 after capsules 24 are delivered. Beveled edges 27 and 28 are oriented such that a V-shaped groove is provided on both an upper portion and a lower portion of adjacent capsules 24, as shown in FIG. 5. Beveled edges 27 and 28 are also designed such that a V-shaped groove is provided on both an anterior portion and a posterior portion of adjacent capsules 24, as shown in FIG. 4.

Referring again to FIG. 3, mutually attracted dental modules 14 are used in a substantially identical way as described above wherein mutually attracted dental modules 14 are releasably coupled by attractive forces to opposite sides of delivery member 12.

The method of applying magnetic orthodontic retainer system 10′ is substantially identical to the method described above for applying magnetic orthodontic retainer system 10. Referring now to FIGS. 3 and 4, the mutual attraction of mutually attracted dental modules 14 retain both capsule 24 and module 14 in place on delivery member 12. Capsules 24 are not bonded to delivery member 12, rather, capsules 24 are held in place via the mutual attraction of mutually attracted dental modules 14 contained therein. A quantity of adhesive 16 is then placed on capsule 24 on surface 25, or, alternatively, adhesive 16 may be applied to capsule 24 prior to placing capsules 24 and modules 14 on opposite sides of delivery member 12. Furthermore, primer material 18 is applied to a posterior surface of adjacent teeth 22, i.e., teeth 22b and 22c, in a location where adhesive 16 applied to capsules 24 will contact the surface of teeth 22b and 22c. Primer material 18 may comprise a material such as acid for etching a posterior surface of each tooth 22. Primer material 18 may also comprise chemical etching or any type of material to facilitate bonding with adhesive 16.

Similar to the method described above, delivery member 12, with mutually attracted dental modules 14 and capsules 24 carried thereon, is placed between a pair of adjacent teeth, for example, between teeth 22b and 22c. Delivery member 12 is then pulled in the general direction of Arrow A, as shown by delivery member 12 being pulled between teeth 22b and 22c. Delivery member 12 is pulled until the pair of capsules 24 contacts adjacent teeth. At this point, adhesive 16 contacts primer material 18. Adhesive 16 is then cured to harden adhesive 16 and attach capsules 24 to teeth 22. In one embodiment, an ultraviolet or visible light source (not shown) may be used to cure adhesive 16.

To complete the operation, delivery member 12 is pulled further anteriorly to remove delivery member 12 from between any teeth, for example, as shown by delivery member 12 removed from between teeth 22e and 22f. Once delivery member 12 has been completely removed, capsules 24, with mutually attracted dental modules 14 retained therein, remain attached to teeth 22e and 22f, for example, to provide an orthodontic retainer. Because capsules 24 are not secured to delivery member 12 and are only carried thereon via the mutual attraction between mutually attracted dental modules 14, delivery member 12 simply slides between capsules 24 and the adjacent teeth to which capsules 24 are attached for removal of delivery member 12 from mouth 20. Movement of delivery member 12 after curing will not disturb capsules 24 because the force coupling capsules 24 to delivery member 12 is less than the force adhering capsules 24 to the teeth. Once placed, mutually attracted dental modules 14 within capsules 24 retain adjacent teeth without the need for other, more cumbersome orthodontic appliances.

Orthodontic retainer system 10″ (not shown) may include capsules 24″ made of mutually attractive material. In one embodiment, capsules 24″ may be formed as a single entity with no separate mutually attracted dental module contained therein. Capsules 24″ could be formed through an injection molding process wherein the entire capsule 24″ would be formed into a mutually attracted dental body, for example, a magnet. In one embodiment, capsule 24″ may be entirely formed of magnetic material.

Although orthodontic retainer systems 10 and 10′ have only been shown as being applied to adjacent anterior teeth in the lower portion of the mouth, the systems may also be applied to any adjacent teeth located anywhere in the mouth. Furthermore, in an alternative embodiment (not shown), orthodontic retainer systems 10 and 10′ may be applied in any position on adjacent teeth as opposed to a lingual position as described hereinabove.

The method of application for orthodontic retainer systems 10 and 10′ described above may also be used in an alternative, indirect application. In an alternative embodiment, orthodontic retainer system 10 or 10′ is applied to an identical, non-human version of mouth 20, for example, a formed mold of mouth 20 including teeth 22. Orthodontic retainer system 10 or 10′ is applied to the formed mold of teeth 22 in an identical fashion as described above. After application to the mold, an orthodontist could use any indirect technique commonly known by the dental profession to simultaneously remove all capsules 24 and/or modules 14 and simultaneously apply all capsules 24 and/or modules 14 in the corresponding patient's mouth 20. All capsules 24 and/or modules 14 may be included in a delivery tray or elastic material having the capability to simultaneously move all capsules 24 and/or modules 14 from the mold to mouth 20.

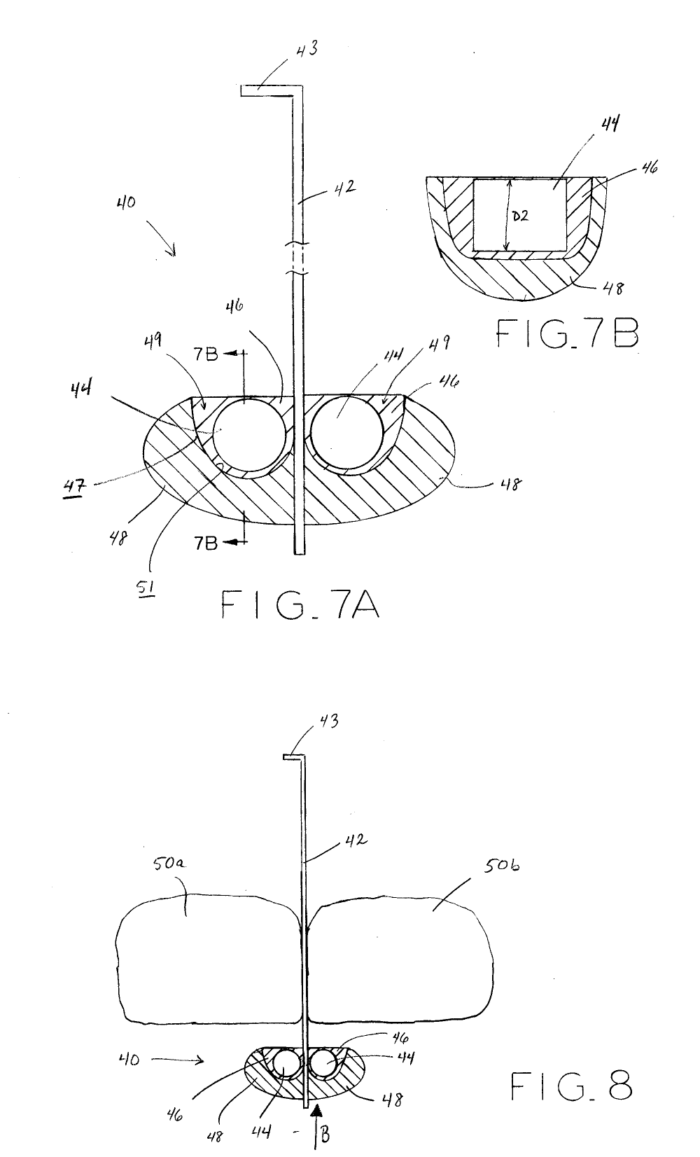

Referring now to FIGS. 7A and 7B, orthodontic retainer system 40 according to another embodiment is shown and may generally include delivery member 42 with handle 43, magnets 44, adhesive 46, and carrier 48. Magnets 44 are releasably coupled by their attractive magnetic forces to opposite sides of delivery member 42. Each magnet 44 may have a first dimension D1 (FIG. 7A), such as a diameter, which may be as small as approximately 0.025, 0.030, 0.035, 0.040, or 0.045 inches or as large as approximately 0.065, 0.060, 0.055, or 0.050 inches, for example. In one form thereof, magnet 44 may be in the shape of a cylinder. Magnet 44 may have a second dimension D2 (FIG. 7B), which may be as small as approximately 0.025, 0.030, 0.035, 0.040, or 0.045 inches or as large as approximately 0.065, 0.060, 0.055, or 0.050 inches, for example. Magnet 44 may also take different shapes or forms, including cross-sectional shapes such as various polygonal shapes. Each magnet 44 may be formed of a biocompatible material to allow its implantation in the mouth for a period of time. For example, each magnet 44 may be formed either partially or completely of gold or neodymium iron.

Delivery member 42 may be substantially similar to delivery member 12, described above with reference to FIGS. 1-3, except as described below. For example, delivery member 42 may be a thin, non-magnetic strip of material, such as Mylar® material, having a thickness T which, in one embodiment, may be as small as 0.001, 0.002, 0.003, 0.004, or 0.005 inches or as large as approximately 0.012, 0.011, 0.010, 0.009, 0.008, 0.007, or 0.006 inches, for example. Thickness T is such as to allow delivery member 42 to pass between a pair of adjacent teeth 50a, 50b. Delivery member 42 may also be formed of a flexible plastic material, such as Mylar® material, for example, or, alternatively, a metal material, such as stainless steel, for example. In one embodiment, delivery member 42 includes a release coating, for example, a silicone, polyethylene, or fluoropolymer coating, such as polytetrafluoroethylene (PTFE) which is commercially available as Teflon® from E. I. du Pont de Nemours and Company of Wilmington, Del.; Silicon Premium, a siloxane release coating commercially available from General Electric Company of Waterford, N.Y.; and Clearsil® fluorosilicone release films and ClearLES™ silicone release liners commercially available from CPFilms, Inc. of Martinsville, Va. The length of delivery member 42 can be any size to facilitate an easy access for an orthodontist for pulling delivery member 42 between a pair of adjacent teeth 50a, 50b. Delivery member 42 may include handle 43 to facilitate movement of delivery member 42.

Adhesive 46 may be substantially similar to adhesive 16, described above with reference to FIGS. 1-4, except as described below. Magnets 44 may be at least partially encapsulated within, or enveloped by, adhesive 46. Adhesive 46 may be any adhesive suitable for a dental application, such as OptiBond®, available from Kerr Corporation of Orange, Calif.; Adper™ and Scotchbond™ adhesives available from 3M Corporation of St. Paul, Minn.; or Xeno® Light Cured Dental Adhesive available from DENTSPLY of York, Pa.

Carrier 48 may include recess 49 defining inner surface 51. Inner surface 51 conforms around magnet 44 and adhesive 46 and, after carrier 48 is removed in the manner described below, defines surface 47 of adhesive 46, which is an envelope or profile of adhesive surrounding magnets 44. Adhesive 46 at least partially surrounds magnets 44 within recess 49. Inner surface 51 may be formed with a generally smooth surface with no protrusions or other edges such that the profile of adhesive 46 thereby created also includes only a smooth surface with no protruding edges for patient comfort after removal of carrier 48 therefrom. In an exemplary embodiment, carrier 48 is formed of a water soluble material, such as polyvinyl alcohol (PVOH) or other water soluble polymer, for example. Carrier 48 may be formed of a material which does not bond with adhesive 46 and which may be removed from adhesive 46 after curing of adhesive 46.

In operation and referring to FIG. 8, the method of using magnetic orthodontic retainer system 40 will be described. To begin, recess 49 of carrier 48 is at least partially filled with adhesive 46. Adhesive 46 may be in the form of a viscous liquid at this stage and magnets 44 are at least partially embedded therein. Adhesive 46 fills recess 49 such that surface 47 of adhesive 46 substantially matches inner surface 51 of recess 49. At this point, adhesive 46 may optionally be partially cured, or pre-cured, with a suitable curing instrument, such as those described below, such that adhesive 46 is a highly viscous or substantially solid material, i.e., in a non-liquid state, to facilitate delivery to teeth 50a, 50b. Magnets 44, along with adhesive 46 and carrier 48, are releasably coupled by attractive forces to opposite sides of delivery member 42, as shown in FIG. 7A. Magnets 44, adhesive 46, and carrier 48 are not bonded to delivery member 42, rather, delivery member 42 functions to carry magnets 44 to their final destination on adjacent teeth. A release coating on delivery member 42, as described above, may further reduce the possibility of adhesive 46 or carrier 48 bonding to delivery member 42. A quantity of primer material (not shown), similar to primer material 18, described above with reference to FIG. 3, may be applied to a lingual surface of adjacent teeth 50a, 50b in a location where adhesive 46 will contact the lingual surface of teeth 50a, 50b.

Delivery member 42, with magnets 44 carried thereon, is placed between a pair of adjacent teeth, for example, between teeth 50a, 50b. Delivery member 42 is then pulled via handle 43, for example, in the general direction of Arrow B (FIG. 8), as shown by delivery member 42 being pulled between teeth 50a, 50b. Arrow B generally indicates a direction away from the lingual side of the teeth and toward the facial side of the teeth. Delivery member 42 is pulled until adhesive 46 and/or magnets 44 contact the lingual surfaces of teeth 50a, 50b, as shown in FIG. 9.

As shown in FIG. 10, adhesive 46 is then fully cured to completely harden adhesive 46 and thereby attach magnets 44 to teeth 50a, 50b. In one embodiment, curing instrument 52 may be used to cure adhesive 46 using curing rays 54. In an exemplary embodiment, curing rays 54 are light rays and curing instrument 52 is a light-based curing instrument. In one embodiment, the light rays are ultraviolet (UV) rays and the light-based curing instrument is a UV-based curing instrument. Examples of light-based curing instruments include the SmartLite®PS LED Curing Light and the Spectrum® 800 Curing Unit with Intensity Control, both available from DENTSPLY of York, Pa. Curing of adhesive 46 solidifies adhesive 46 and securely attaches adhesive 46 and magnets 44 to each of teeth 50a, 50b. Curing of adhesive 46 within recess 49 of carrier 48 ensures that adhesive 46 has a profile substantially matching inner surface 51 of recess 49. The profile of adhesive 46 advantageously has no edges or protrusions and provides a smooth and non-irritating lingual surface 47, as described further below.

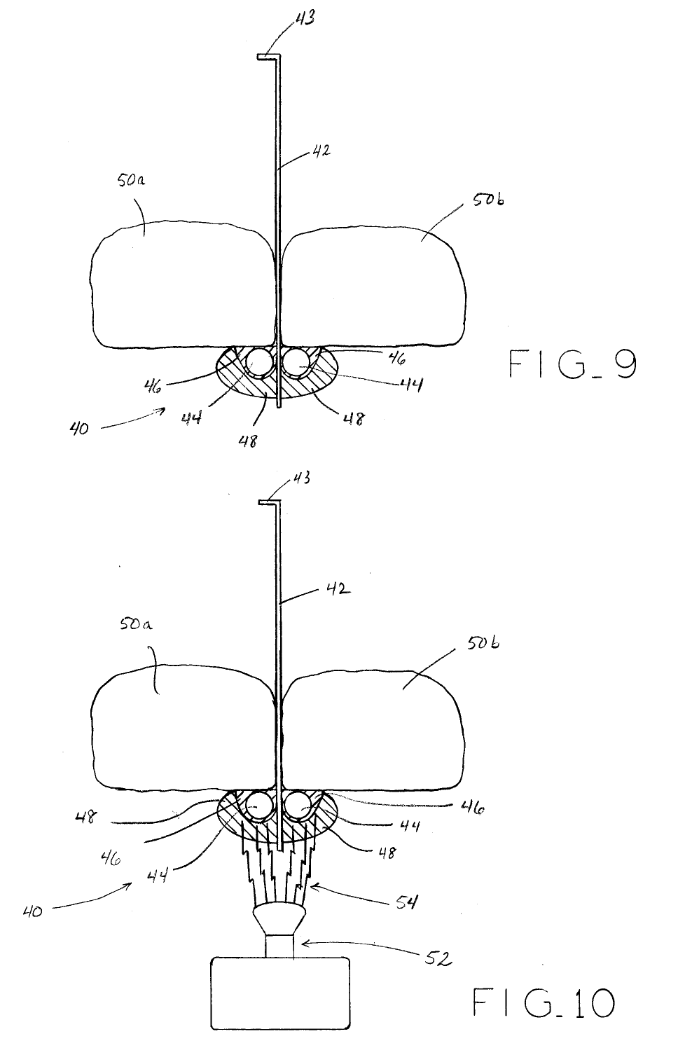

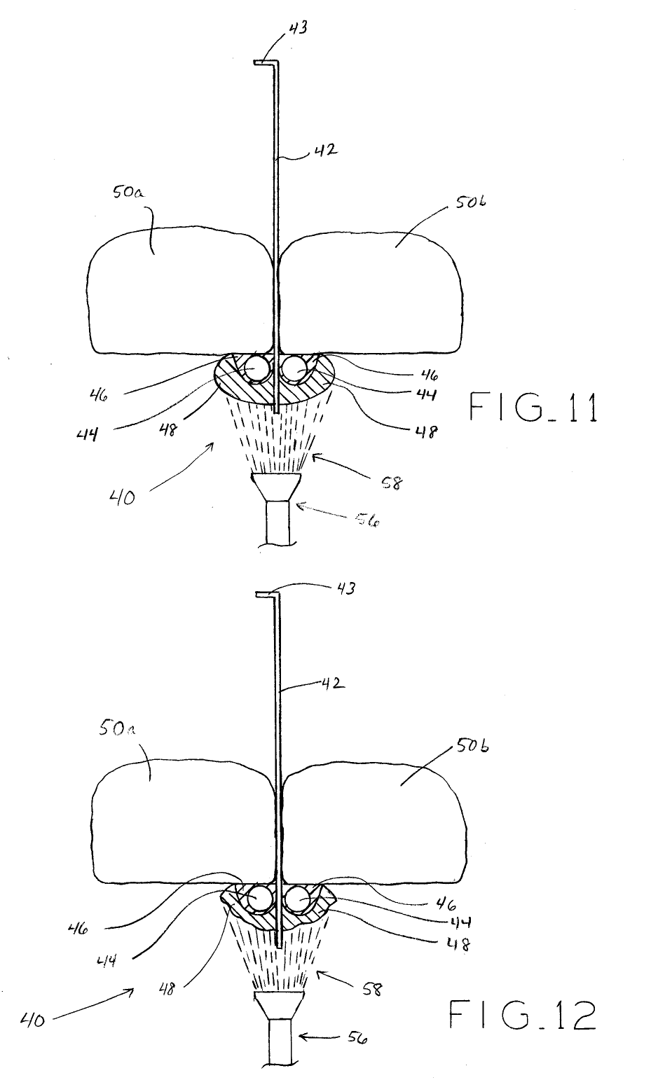

Referring to FIG. 11, carrier 48 may be removed from adhesive 46 to reveal surface 47 which has a substantially smooth profile. Carrier 48 shown in FIG. 11 may be formed of a water soluble material, such as a water soluble polymer, i.e., polyvinyl alcohol (PVA or PVOH), for example. Water source 56 may supply an amount of water 58 or other water-based solution onto carrier 48. Water source 56 may be any suitable water supply instrument, such as the Waterpik® Dental Water Jet, available from Waterpik Technologies, Inc. of Newport Beach, Calif.; and the Interplak® Dental Water jet, available from Conair of Stamford, Conn., for example. Because carrier 48 is formed of a water-soluble material, application of water 58 dissolves carrier 48. As shown in FIG. 12, carrier 48 is partially dissolved. In one embodiment, suction may be applied adjacent water source 56 to remove water 58 and portions of carrier 48 which are dissolved. Carrier 48 may be formed of a material that is not harmful if swallowed.

Referring to FIG. 13, further application of water 58 substantially and completely dissolves carrier 48 (FIGS. 11 and 12) such that adhesive 46 and magnets 44 are the only portion of system 40 to remain. Dissolving carrier 48 reveals a smooth lingual surface 47 of adhesive 46 defining a smooth profile of adhesive 46 which is completely cured to secure magnets 44 to teeth 50a, 50b. In an exemplary embodiment, lingual surface 47 of adhesive 46 is a substantially smooth surface with no sharp edges or projections. Such a smooth surface facilitates comfort for the patient. Advantageously, adhesive 46 requires no post-curing formation, such as by removing and/or manually forming adhesive 46 around magnets 44 to obtain a desired profile of adhesive 46, thereby greatly reducing the time needed for an orthodontist to apply magnets to a patient's dentition. For example, if the orthodontist has a large number of magnets to apply, system 40 greatly reduces the time required for such a procedure. The present method eliminates such post-curing formation and provides a fully cured and shaped profile for adhesive 46 which is both comfortable for a user of system 40 and is aesthetically pleasing. The shaped profile of adhesive 46 advantageously provides a comfortable retainer system for the patient and blends into the surrounding teeth proximate teeth 50a, 40b. Furthermore, adhesive 46 may be colored such that, when fully cured, adhesive 46 is substantially the same color as teeth 50a, 50b to which adhesive 46 is secured.

To complete the operation, delivery member 42 may be pulled and/or otherwise removed from between teeth 50a, 50b. Once delivery member 42 has been completely removed, magnets 44 with adhesive 46 remain attached to teeth 50a, 50b, for example, to provide an orthodontic retainer system, as shown in FIG. 13. Because magnets 44 and adhesive 46 are not secured to delivery member 42 and are only carried thereon via the mutual attraction between magnets 44, delivery member 42 simply slides between magnets 44 and adhesive 46 and the adjacent teeth to which adhesive 46 and magnets 44 are attached for removal of delivery member 42 from the mouth of the patient. Movement of delivery member 42 after curing of adhesive 46 will not disturb adhesive 46 and magnets 44 because the force coupling magnets 44 and adhesive 46 to delivery member 42 is less than the force adhering adhesive 46 and magnets 44 to the teeth. Once fixed in position, magnets 44 retain adjacent teeth without the need for other, more cumbersome orthodontic appliances. Although described above as removing delivery member 42 after removal of carrier 48, practice of the present method may alternatively involve removal of delivery member 42 first, followed by removal of carrier 48.

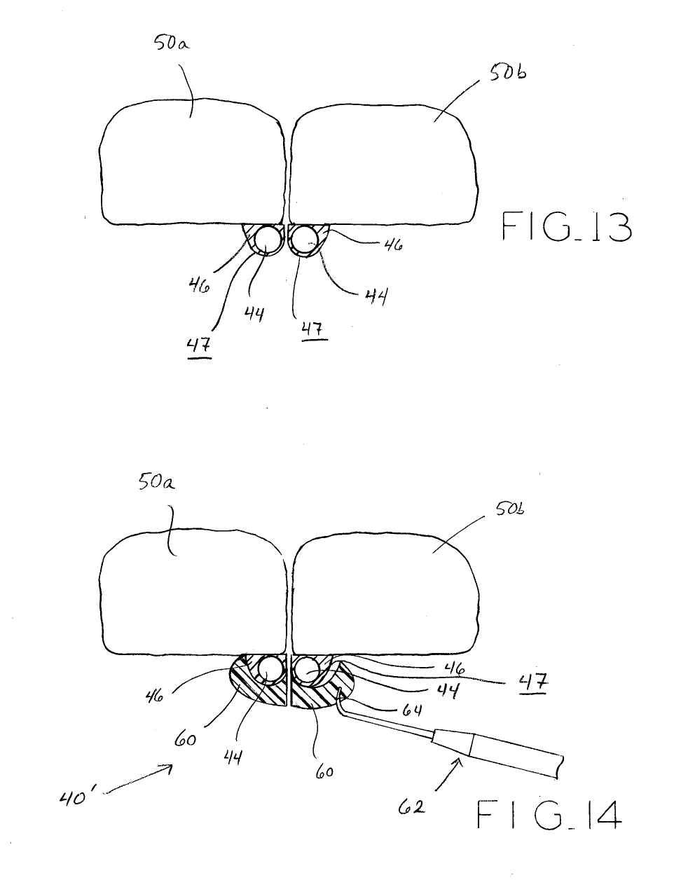

Referring to FIG. 14, an alternative embodiment retainer system 40′ is shown and generally includes delivery member 42 with handle 43, magnets 44, adhesive 46, and carrier 60. Carrier 60 may be formed of a flexible material which does not bond with adhesive 46 and which may be removed from adhesive 46 after curing of adhesive 46. In an exemplary embodiment, carrier 60 is formed of a flexible silicone-based material which may be peeled off adhesive 46 using scaler 64 or another suitable dental instrument 62. Scaler 64 may pierce carrier 60 after which carrier 60 is peeled or pulled away from adhesive 46 to reveal the substantially smooth envelope or profile of adhesive 46, as described above. Alternatively, carrier 60 may be removed via any other instrument or by hand. For example, dental instrument 62 may include forceps which are used to grasp a portion of carrier 60 and remove carrier 60 to reveal the profile of adhesive 46.

While this disclosure has been described as having exemplary designs, the present disclosure may be further modified within the spirit and scope of this disclosure. This application is therefore intended to cover any variations, uses, or adaptations of the disclosure using its general principles.

What is claimed is:

1. An orthodontic retainer system for use on teeth, comprising:
a delivery member;
at least one carrier including a recess, said carrier coupled to said delivery member;
an adhesive material contained within said recess; and
at least one magnet disposed within said recess and at least partially surrounded by said adhesive.

2. The retainer system of claim 1, wherein said at least one magnet comprises a pair of magnets.

3. The retainer system of claim 2, wherein said carrier is coupled to another said carrier via mutual attraction between said pair of magnets.

4. The retainer system of claim 1, wherein said at least one carrier includes a pair of recesses, each said recess including one of said at least one magnet.

5. The retainer system of claim 1, wherein said carrier is formed of a water soluble material.

6. The retainer system of claim 1, wherein said carrier is formed of a flexible material.

7. The retainer system of claim 1, wherein said recess defines a substantially smooth surface, said adhesive material substantially conforming to said substantially smooth surface.

8. The retainer system of claim 1, wherein said delivery member comprises a substantially thin piece of flexible material.

9. The retainer system of claim 1, wherein said adhesive material is colored to substantially match a color of the teeth.

10. A method of applying a pair of magnets to a pair of adjacent teeth each having a lingual side, comprising the steps of:
providing at least one carrier having a recess containing an adhesive material and a pair of magnets;
abutting the adhesive material with the lingual side of each of the pair of adjacent teeth;
curing the adhesive material; and
removing the carrier from the adhesive material.

11. The method of claim 10, wherein said removing step further comprises the step of revealing a smooth profile of the adhesive material which substantially surrounds the magnets.

12. The method of claim 10, wherein said curing step comprises the step of curing the adhesive material to form a substantially smooth profile of the adhesive material.

13. The method of claim 10, wherein said curing step comprises the step of light-curing the adhesive material.

14. The method of claim 10, wherein said removing step comprises the step of dissolving the carrier by applying water.

15. The method of claim 10, wherein said removing step comprises the step of using a dental instrument to pull the carrier away from the adhesive material.

16. The method of claim 10, wherein said providing step further comprises providing a delivery member on which the carrier, the adhesive material, and the pair of magnets are positioned and said abutting step further comprises moving the delivery member between the pair of adjacent teeth until said abutting step.

17. A method of applying a pair of magnets to a pair of adjacent teeth each having a lingual side, comprising the steps of:
magnetically coupling the pair of magnets to one another on opposite sides of a delivery member with the delivery member captured therebetween;
abutting the pair of magnets with the lingual side of each of the pair of adjacent teeth by sliding the delivery member between the pair of adjacent teeth; and
securing the pair of magnets respectively to the pair of adjacent teeth such that the pair of magnets are maintained in non-contact relationship with each other.

18. The method of claim 17, wherein said securing step further comprises maintaining a gap between the pair of magnets.

19. The method of claim 18, wherein the gap is between approximately 0.001 inches and 0.012 inches.

20. The method of claim 17, wherein said securing step further comprises curing an adhesive associated with the pair of magnets.

21. The method of claim 20, wherein said securing step further comprises removing a carrier which contains the adhesive and the pair of magnets.
